(19) United States
(12) Patent Application Publication
(10) Pub. No.: US 2006/0144237 A1
(43) Pub. Date: Jul. 6, 2006

(54) Microminiature gas chromatograph column

(76) Inventors: Dong Liang, Beijing (CN); Wanli Xing, Beijing (CN); Jing Cheng, Beijing (CN)

Correspondence Address: MORRISON & FOERSTER LLP, 12531 HIGH BLUFF DRIVE, SUITE 100, SAN DIEGO, CA, 92130-2040, US

(21) Appl. No.: 10/537,533

(22) PCT Filed: Dec. 31, 2002
(86) PCT No.: PCT/CN02/00941

§ 371 Date: Jan. 30, 2006

(30) Foreign Application Priority Data
Dec. 5, 2002 (CN) 02153851.4

(51) Int. Cl. B01D 53/02; B01D 53/14

(52) U.S. Cl. 96/101

(57) ABSTRACT

This invention relates to the field of miniaturing gas chromatograph instruments using microfabrication technologies. In particular, the invention provides a gas chromatograph column, which column comprises at least two lid layers and a channel layer, wherein each of said layers comprises a compact material suitable for gas chromatograph, said channel layer comprises microfabricated channels on both sides, said microfabricated channels and a side of said lid layers form at least two capillaries, said at least two capillaries are connected to each other through a hole in said channel layer to form an integrated capillary, said integrated capillary is connected to outside atmosphere on both ends via holes on two outmost lid layers to serve as an inlet and an outlet.

### TECHNICAL FIELD

This invention relates to the field of miniaturing gas chromatograph instruments using microfabrication technologies. In particular, the invention provides for a gas chromatograph column, which column comprises at least two lid layers and a channel layer, wherein each of said layers comprises a compact material suitable for gas chromatograph, said channel layer comprises microfabricated channels on both sides, said microfabricated channels and a side of said lid layers form at least two capillaries, said at least two capillaries are connected to each other through a hole in said channel layer to form an integrated capillary, said integrated capillary is connected to outside atmosphere on both ends via holes on two outmost lid layers to serve as an inlet and an outlet.

### BACKGROUND ART

Gas chromatographs are used by various scientific laboratories and government law enforcement agencies to analyze the chemical makeup of samples of materials. Some of such instruments are able to reliably analyze sample where the constituents are concentrated as low as one part per million. Prior art equipment can provide useful results, but such equipment is extraordinary bulky and too delicate to be called portable.

Gas chromatographs generally comprise three basic parts, an injector, a column, and a detector. The column generally comprises a tube coated with a stationary phase, through which a carrier phase must migrate. Gas samples are carried into a column by a carrier gas such as hydrogen or helium. The separation effects are dependent on many factors, among which the length of the column is a very important one.

Microfabrication technologies make it possible to build up a really potable gas chromatograph. The prior art, however, has not succeeded in the analysis of certain liquid samples with microfabricated gas chromatograph columns. The main reason is that the microfabricated gas chromatograph columns are not long enough to attain satisfying separation effects.

There exists a need in the art for sensitive and miniatured gas chromatograph instruments. This invention address this and other related needs in the art.

### DISCLOSURE OF THE INVENTION

In one aspect, the present invention is directed to a gas chromatograph column, which column comprises at least two lid layers and a channel layer, wherein each of said layers comprises a compact material suitable for gas chromatograph, said channel layer comprises microfabricated channels on both sides, said microfabricated channels and a side of said lid layers form at least two capillaries, said at least two capillaries are connected to each other through a hole in said channel layer to form an integrated capillary, said integrated capillary is connected to outside atmosphere on both ends via holes on two outmost lid layers to serve as an inlet and an outlet.

In another aspect, the present invention is directed to a gas chromatograph column, which column comprises at least two lid layers and at least two channel layers, wherein each of said layers comprises a compact material suitable for gas chromatograph, said channel layers comprise microfabricated channels on a side, said microfabricated channels and a side of said lid or channel layers form at least two capillaries, said at least two capillaries are connected to each other through a hole in said channel and/or lid layer to form an integrated capillary, said integrated capillary is connected to outside atmosphere on both ends via holes on two outmost lid layers to serve as an inlet and an outlet.

In still another aspect, the present invention is directed to a gas chromatograph system, which system comprises: a) a gas injector for introducing a mobile phase including a sample gas in a carrier gas; b) an above-described gas chromatograph column comprising a stationary phase suitable for gas chromatograph and mechanically connected to receive said mobile phase from said gas injector for the separation of an analyte in said sample gas; and c) a detector mechanically connected to said column for the analysis of said separated analyte of said sample gas with an electronic means.

In yet another aspect, the present invention is directed to a method for analyzing an analyte in a sample, which method comprises: a) providing an above-described gas chromatograph system; b) vaporizing a sample to a gas phase; c) injecting said sample gas in a carrier gas into said gas chromatograph system; and d) allowing separation and detection of an analyte in said sample in said gas chromatograph system to assess the presence, absence or amount of said analyte in said sample.

### BRIEF DESCRIPTION OF THE DRAWINGS

FIGS. 1A and 1B are exploded assembly diagrams of an exemplary microfabricated gas chromatograph column.

FIG. 2 is a perspective view of the middle layer (2) of the exemplary microfabricated gas chromatograph column shown in FIGS. 1A and 1B.

FIG. 3 illustrates an extension from 3 layers to 5 layers in an exemplary microfabricated gas chromatograph column.

### MODES OF CARRYING OUT THE INVENTION

For clarity of disclosure, and not by way of limitation, the detailed description of the invention is divided into the subsections that follow.

### A. DEFINITIONS

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in the patents, applications, published applications and other publications that are herein incorporated by reference, the definition set forth in this section prevails over the definition that is incorporated herein by reference.

As used herein, “a” or “an” means “at least one” or “one or more.”

As used herein, “chromatography” refers to a method to separate, identify or prepare a component from a mixture.

As used herein, “column chromatography” refers to a type of chromatography that uses a column filled or coated with a finely divided solid or liquid, a “stationary phase.” A mixture of materials to be separated is placed at the top of the column and is moved down with a suitable liquid, eluent or carrying gas, a “mobile phase.” As the mixture dissolves, each molecule is transported in the flowing liquid or carrying gas and becomes adsorbed into the stationary solid or liquid. Each type of molecule spends a different amount of time in the column, depending on its tendency to be adsorbed. Thus each compound descends through the column at a different rate.

As used herein, “gas chromatography” refers to a type of chromatography that invovles passage of a gaseous moving phase through a column containg a stationary phase.

As used herein, “sample” refers to anything which may contain an analyte to be separated, isolated, prepared and/or analyzed using the present columns, systems and/or mehtods.

As used herein the term “assessing” is intended to include quantitative and/or qualitative determination of an analyte present in the sample, and also of obtaining an index, ratio, percentage, visual or other value indicative of the level of the analyte in the sample. Assessment may be direct or indirect and the chemical species actually detected need not of course be the analyte itself but may for example be a derivative thereof or some further substance.

### B. GAS CHROMATOGRAPH COLUMNS AND SYSTEMS

In one aspect, the present invention is directed to a gas chromatograph column, which column comprises at least two lid layers and a channel layer, wherein each of said layers comprises a compact material suitable for gas chromatograph, said channel layer comprises microfabricated channels on both sides, said microfabricated channels and a side of said lid layers form at least two capillaries, said at least two capillaries are connected to each other through a hole in said channel layer to form an integrated capillary, said integrated capillary is connected to outside atmosphere on both ends via holes on two outmost lid layers to serve as an inlet and an outlet.

The present gas chromatograph column should comprise at least two lid layers and at least one channel layer. In one example, the present gas chromatograph column comprises more than two lid layers and more than one channel layer and an integrated capillary is formed through all the lid and channel layers. In another example, the present gas chromatograph column comprises three lid layers and two channel layers and an integrated capillary is formed through all the lid and channel layers.

Any suitable compact material can be used in the present gas chromatograph column. For example, the compact material can be metal, polymer, ceramic, silicon, quartz, glass and a combination thereof. Preferably, the compact material is a non-porous material. The lid layers and the channel layer(s) can comprise same or different compact material(s).

The lid layers and the channel layer(s) can have any suitable size(s) or shape(s). In one example, the lid layers have an area ranging from about 1 to about 100 cm². In another example, the channel layer has an area ranging from about 1 to about 100 cm². The lid layers and the channel layer(s) can have same or different area(s). In still another example, the lid layers and the channel layer(s) can have a thickness ranging from about 0.1 to about 5 mm.

The microfabricated channels on the channel layer(s) can have any suitable size(s) or shape(s). In one example, the microfabricated channels can have a width ranging from about 1 to about 1,000 microns. In another example, the microfabricated channels can have a depth ranging from about 3 to about 500 microns.

The microfabricated channels can be formed on the channel layer(s) by any sutaible methods. In one example, the microfabricated channels are formed by a wet etching method using a mixture of HF, HNO₃ and CH₃COOH. In another example, the microfabricated channels are formed by a dry etching method, e.g., reactive ion etching (RIE).

The formed integrated capillary can have any suitable size(s) or shape(s). In one example, the integrated capillary has a total length of at least 4 meters. In another example, the integrated capillary has a sectional shape of a trapezia, a rectangle, a circle, a semicircle, a sector or a combination thereof. The cross-section of the integrated capillary can have an area ranging from about 5 to about 250,000 square microns. The integrated capillary can have identical or different cross-section area(s) along its length. The integrated capillary can have a serpentine or spiral pattern.

The wall of the integrated capillary can be coated with a thin film of a stationary phase. The stationary phase can be coated by any suitable methods. For example, the stationary phase can be applied via a deposition method (See e.g. Lehmann et al., Proceeding Sensor '97, 151-153, a dynamic lining method (See e.g., Schomburg and Husmann, Chromatographia, 8:517-530 (1975)), or a static lining method (See e.g., Janak et al., J. High Resolution Chromatography & Chromatography Communications, 8:843-847, (1985)). The stationary phase can be applied before or after the layers are bound together.

The hole(s) in the channel layer and the holes in the lid layers can have any suitable size(s) or shape(s). For example, the hole in the channel layer and the holes in the lid layers can have a square or a round shape. The hole(s) in the channel layer and the holes in the lid layers can be formed by any suitable methods. For example, the hole in the channel layer and the holes in the lid layers can be formed by laser ablation (See e.g., Dirk et al., Applied Surface Science, 150:185-189 (1999), micromachining (See e.g., Diepold and Obermeier, Technical Digest Microsystem Technologies, 211-216 (1996) or etching (See e.g., Terry et al., IEEE Transactions on Electron Devices, ED-26 (No. 12):1880-1886 (1979)).

The lid layers and the channel layer(s) can be bound together by any suitable methods. For example, the layers can be bound together by anodic bonding (See e.g., Thomas et al., Sensors and Actuators, 86:103-107 (2000)), ultrasonic welding (See e.g., http://www.tops-mate.com/uwm_intro.htm), heat bonding (See e.g., Paulus et al., Proceedings SPIE Microfluidic Devices and Systems, 3515:94-103 (1998)) or gluing (See e.g., Roberts et al., Analytic Chemistry, 69:2035-2042 (1997)).

The present gas chromatograph column can comprise any suitable additional components. For example, the present gas chromatograph column can further comprise a heater wire deposited on an outside surface of the integrated capillary to provide for electric heating of a stationary phase material within the integrated capillary during operation of a gas chromatograph.

In another aspect, the present invention is directed to a gas chromatograph system, which system comprises: a) a gas injector for introducing a mobile phase including a sample gas in a carrier gas; b) an above-described gas chromatograph column comprising a stationary phase suitable for gas chromatograph and mechanically connected to receive said mobile phase from said gas injector for the separation of an analyte in said sample gas; and c) a detector mechanically connected to said column for the analysis of said separated analyte of said sample gas with an electronic means.

In still another aspect, the present invention is directed to a gas chromatograph column, which column comprises at least two lid layers and at least two channel layers, wherein each of said layers comprises a compact material suitable for gas chromatograph, said channel layers comprise microfabricated channels on a side, said microfabricated channels and a side of said lid or channel layers form at least two capillaries, said at least two capillaries are connected to each other through a hole in said channel and/or lid layer to form an integrated capillary, said integrated capillary is connected to outside atmosphere on both ends via holes on two outmost lid layers to serve as an inlet and an outlet.

Preferably, at least one of the channel layers comprises microfabricated channels on one side and the other side of the same channel layer directly faces microfabricated channels of another channel layer to form a capillary. Also preferbaly, at least one of the channel layers comprises microfabricated channels on both sides and said microfabricated channels and a side of the lid layers form at least two capillaries.

The present gas chromatograph columns can be used in any suitable gas chromatograph systems. See e.g., U.S. Pat. Nos 5,583,281 and 6,068,780. Mobile phase must be a gas phase and stationary phases are either liquids adsorbed on solid carriers or solids. When a liquid stationary phase is used, the process is called partition chromatography, since the mixture to be analyzed will be partitioned, or distributed, between the stationary liquid and a separate liquid mobile phase. Where the stationary phase is solid, the process is known as adsorption chromatography. The molecules of the mixture to be separated pass many times between the mobile and stationary phases at a rate that depends on the mobility of the molecules, the temperature, and the binding forces involved. The difference in the time that each type of molecule spends in the mobile phase leads to a difference in the transport velocity and to the separation of substances.

Exemplary adsorbents are silica gel and alumina, which are often powdered into particles between 0.05 and 0.2 mm (0.002 to 0.08 in) in diameter for optimal flow. Stationary phases with very different properties can be obtained; and many different mixtures can be separated if a suitable adsorbent is chosen, and the powder is impregnated with a liquid.

Gas chromatography includes gas-liquid chromatography (GLC) and the less common gas-solid (GSC) method. The stationary phase can be a liquid on a solid support. The mobile phase can be an inert gas, usually nitrogen, hydrogen, helium, or argon, which is passed through a heated column. The sample mixture can be injected into the column and immediately vaporizes. Its constituent substances separate and flow at different rates with the carrier gas. A detector can be placed at the end of the column, which outputs a signal to a recorder in the form of a gas chromatogram having a series of detector maximums. Each peak is characteristic of a particular substance in the sample gas.

### C. METHODS FOR ANALYZING ANALYTES USING GAS CHROMATOGRAPH

In yet another aspect, the present invention is directed to a method for analyzing an analyte in a sample, which method comprises: a) providing an above-described gas chromatograph system; b) vaporizing a sample to a gas phase; c) injecting said sample gas in a carrier gas into said gas chromatograph system; and d) allowing separation and detection of an analyte in said sample in said gas chromatograph system to assess the presence, absence or amount of said analyte in said sample.

The present methods can be used for analyzing any suitable analyte. For example, any analyte that can be vapourized at a temperature lower than 400° C. without decomposition can be analyzed by the present methods. The present methods can be used for analyzing a molecule or an aggregate or complex thereof. The molecule can be an inorganic molecule, an organic molecule and a complex thereof. Exemplary organic molecule can be can be a hydrocarbon or any molecule with hydrocarbon as its backbone. In one specific embodiment, the present methods can be used for analyzing a chemical compound, a metabolite of a chemical compound and a complex thereof.

The present methods can be used for analyzing any suitable sample. For example, the present methods can be used for analyzing a mammalian sample, e.g., a bovine, goat, sheep, equine, rabbit, guinea pig, murine, human, feline, monkey, dog or porcine sample. In another example, the present methods can be used for analyzing a clinical sample. Exemplary clinical samples inlcude serum, plasma, whole blood, sputum, cerebral spinal fluid, amniotic fluid, urine, gastrointestinal contents, hair, saliva, sweat, gum scrapings and tissue from biopsies. Preferably, the clinical sample is a human clinical sample. Also preferably, the present methods can be used for analyzing a body fluid sample. Still preferably, the present methods can be used for analyzing atmosphere, water, soil, drug or explosive sample. If desirable or necessary, the samplaes can be pretreated before subjected to gas chromatography analysis.

Any suitable carrier gas can be used in the present methods. Preferably, the carrier gas is an inert gas, e.g., nitrogen, hydrogen, helium and argon.

The sample can be vaporized by any suitable methods. For example, the sample can be vaporized in a carrier gas. Alternatively, the sample can be vaporized in the absence of a carrier gas and is then mixed before or while injected into the gas chromatograph system.

### D. EXEMPLARY EMBODIMENTS

The object of this specific embodiment is to attain a type of microfabricated gas chromatograph columns as long as conventional fused silica capillary columns widely used. Another object of this specific embodiment is to attain a more compact structure than that of the prior microfabricated gas chromatograph columns.

Briefly, a microfabricated gas chromatograph column of the present embodiment is fabricated by bonding more than 2 layers together. Micro channels are formed by etching in some of the layers, and then covered by some other layers to build up integrated capillaries. Each layer has at least one function, either to form a channel or to cover the channel to form an integrated capillary, or has both functions. To connect the ends of two capillaries next to each other in different layers, a through hole is formed in the layer between the two capillaries. Thus all the capillaries are connected together to build up a whole long capillary. The whole long capillary opens into the atmosphere at both ends by through holes in the top layer and the bottom layer separately, which holes function as inlet or outlet for the carrier gas. Once all the layers are bonded together to build up the whole long capillary, a solution of some kind of stationary phase in organic solvent, such as SE-30 solved in chloroform, is injected to fill up the whole long capillary. The chloroform is then evaporated out slowly to leave the stationary phase behind in a deposit. Another method of coating with a stationary phase is to deposit the stationary phase onto the wall of the-to-be-formed capillaries before the layers are bonded together.

An advantage of this specific embodiment is that it arranges the capillaries in the column into no less than 2 layers and provides a more compact structure than that of the prior microfabricated gas chromatograph columns. Another advantage of this specific embodiment is that the extension of the number of layers is made relatively easy.

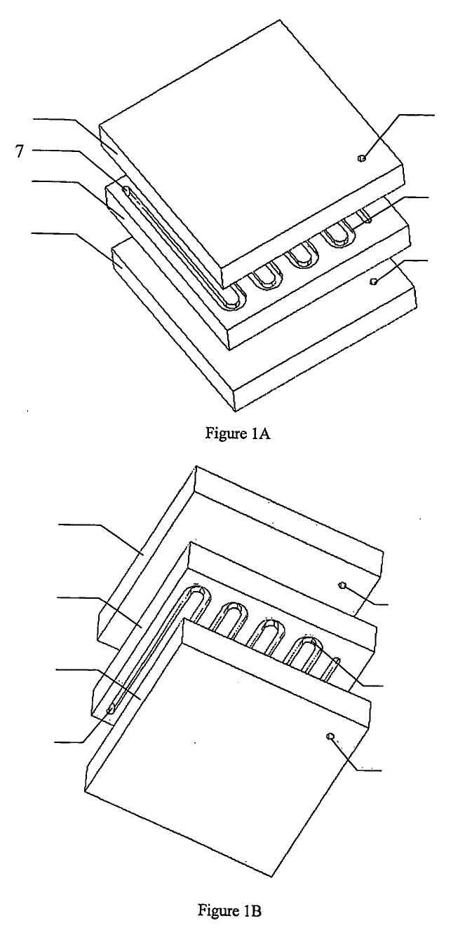

FIGS. 1A and 1B are exploded assembly diagrams of the present embodiment. Such an embodiment comprises tree layers (1, 2, and 3), the materials of which can be glass, silicon, quartz, metal or any other compact materials. Two channels (5 and 8) are formed by etching on both sides of the middle layer (2), e.g., with heated aqueous solution of KOH or HF—HNO₃, or by dry etching methods such as DRIE (Deep Reactive Ion Etching). The other two layers function as lids covering the channels to build up integrated capillaries. The way to bond the layers together can be gluing, ultrasonic welding, anodic bonding, or any other feasible methods. A through hole (7) is formed in the middle layer (2), e.g., by drilling or laser ablation, to connect these channels (5 and 8) at their ends building up a whole long capillary. The length of the whole long capillary ranges between 4 and 50 meters. Two other holes are formed in the same way in the upper and lower layers (1 and 3) separately to connect the whole long capillary to the outside.

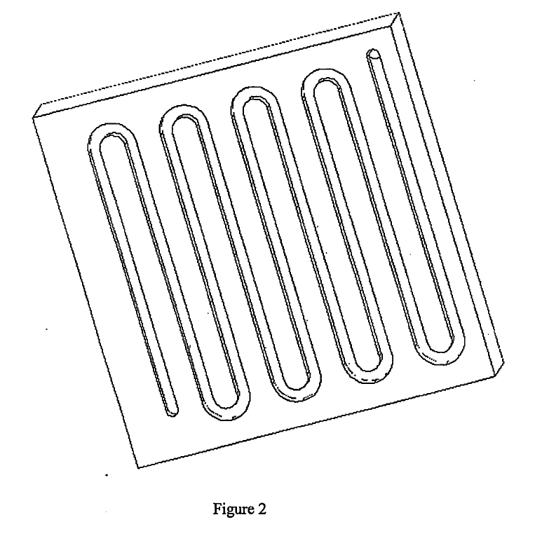

FIG. 2 is a perspective view of the middle layer (2) shown in FIG. 1A and 1B. The channel (8) in one of the surfaces of the middle layer (2) and the through hole (7) in the middle layer (2) can be seen more clearly from this angle of view. The width of the channel ranges between 1 and 500 microns, and the depth ranges between 3 and 500 microns. The pattern to dispose the capillaries is not confined to be serpentine. It can also be spiral, or any other patterns. The thickness of each layer ranges from 0.2 to 5 millimeters, and the area of each layer ranges between 1 and 10,000 square centimeters. A larger area can help to dispose longer capillaries.

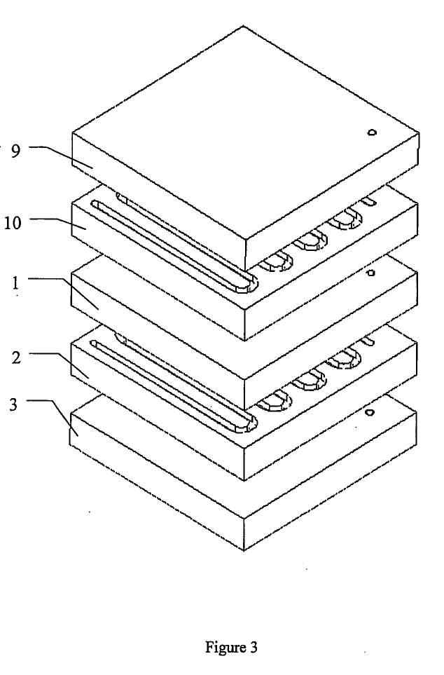

FIG. 3 is a diagram of an extension from 3 layers to 5 layers according to the present embodiment. By this extension, the length of the whole long capillary is doubled.

To coat the wall of the capillary, the classical static or dynamic lining methods can be used. The classical static lining method is to fill up the capillary with a solution of the stationary phase, e.g., SE-30 solved in chloroform, and then to evaporate out the solvent leaving the stationary phase behind in a deposit. The classical dynamic lining method is to push some solution of the stationary phase with pressure through the capillary leaving a little of stationary phase behind in a deposit. A novel method to coat the wall of the capillary is to deposit the stationary phase on the walls of the channels and corresponding regions of the cover layer surfaces before bonding the layers together.

### E. EXAMPLES

1. Drug testing

The substance extracetd from human urine can be injected as a sample into the gas chromatograph system. The components of the urine sample is separated by the column chromatography as described above, and then detected by a detector and reported to a user. If the individual from whom the urine sampel is obtained has taken in some drug(s), the metabolite of the drug(s) may be found in the sample.

2. Pesticide testing

A vegetable can be crushed and substances extracted from the crumb can be injected as a sample into the gas chromatograph system. According to the analytic result, it can be assessed whether the vegetable contains a pesticide.

The above examples are included for illustrative purposes only and are not intended to limit the scope of the invention. Many variations to those described above are possible. Since modifications and variations to the examples described above will be apparent to those of skill in this art, it is intended that this invention be limited only by the scope of the appended claims.

What is claimed is:

1. A gas chromatograph column, which column comprises at least two lid layers and a channel layer, wherein each of said layers comprises a compact material suitable for gas chromatograph, said channel layer comprises microfabricated channels on both sides, said microfabricated channels and a side of said lid layers form at least two capillaries, said at least two capillaries are connected to each other through a hole in said channel layer to form an integrated capillary, said integrated capillary is connected to outside atmosphere on both ends via holes on two outmost lid layers to serve as an inlet and an outlet.

2. The gas chromatograph column of claim 1, which comprises more than two lid layers and more than one channel layer and an integrated capillary is formed through all the lid and channel layers.

3. The gas chromatograph column of claim 1, which comprises three lid layers and two channel layers and an integrated capillary is formed through all the lid and channel layers.

4. The gas chromatograph column of claim 1, wherein the compact material is selected from the group consisting of metal, polymer, ceramic, silicon, quartz, glass and a combination thereof.

5. The gas chromatograph column of claim 1, wherein the lid layers and the channel layer comprise same or different compact material(s).

6. The gas chromatograph column of claim 1, wherein the lid layers have an area ranging from about 1 to about 100 cm².

7. The gas chromatograph column of claim 1, wherein the channel layer has an area ranging from about 1 to about 100 cm².

8. The gas chromatograph column of claim 1, wherein the lid layers and the channel layer have same or different area(s).

9. The gas chromatograph column of claim 1, wherein the lid layers and the channel layer have a thickness ranging from about 0.1 to about 5 mm.

10. The gas chromatograph column of claim 1, wherein the microfabricated channels have a width ranging from about 1 to about 1,000 microns.

11. The gas chromatograph column of claim 1, wherein the microfabricated channels have a depth ranging from about 3 to about 500 microns.

12. The gas chromatograph column of claim 1, wherein the microfabricated channels are formed by a wet etching method.

13. The gas chromatograph column of claim 1, wherein the microfabricated channels are formed by a dry etching method.

14. The gas chromatograph column of claim 1, wherein the integrated capillary has a total length of at least 4 meters.

15. The gas chromatograph column of claim 1, wherein the integrated capillary has a sectional shape selected from the group consisting of a trapezia, a rectangle, a circle, a semicircle, a sector and a combination thereof.

16. The gas chromatograph column of claim 1, wherein the cross-section of the integrated capillary has an area ranging from about 5 to about 250,000 square microns.

17. The gas chromatograph column of claim 1, wherein the integrated capillary has identical or different cross-section area(s) along its length.

18. The gas chromatograph column of claim 1, wherein the integrated capillary has a serpentine or spiral pattern.

19. The gas chromatograph column of claim 1, wherein the wall of the integrated capillary is coated with a thin film of a stationary phase.

20. The gas chromatograph column of claim 19, wherein the stationary phase is applied via a deposition method, a dynamic lining method or a static lining method.

21. The gas chromatograph column of claim 19, wherein the stationary phase is applied before or after the layers are bound together.

22. The gas chromatograph column of claim 1, wherein the hole in the channel layer and the holes in the lid layers have a square or a round shape.

23. The gas chromatograph column of claim 1, wherein the hole in the channel layer and the holes in the lid layers are formed by laser ablation, micromachining or etching.

24. The gas chromatograph column of claim 1, wherein the layers are bound together by anodic bonding, ultrasonic welding, heat bonding or gluing.

25. The gas chromatograph column of claim 1, which further comprises a heater wire deposited on an outside surface of the integrated capillary to provide for electric heating of a stationary phase material within the integrated capillary during operation of a gas chromatograph.

26. A gas chromatograph column, which column comprises at least two lid layers and at least two channel layers, wherein each of said layers comprises a compact material suitable for gas chromatograph, said channel layers comprise microfabricated channels on a side, said microfabricated channels and a side of said lid or channel layers form at least two capillaries, said at least two capillaries are connected to each other through a hole in said channel and/or lid layer to form an integrated capillary, said integrated capillary is connected to outside atmosphere on both ends via holes on two outmost lid layers to serve as an inlet and an outlet.

27. The gas chromatograph column of claim 26, wherein at least one of the channel layers comprises microfabricated channels on one side and the other side of the same channel layer directly faces microfabricated channels of another channel layer to form a capillary.

28. The gas chromatograph column of claim 26, wherein at least one of the channel layers comprises microfabricated channels on both sides and said microfabricated channels and a side of the lid layers form at least two capillaries.

29. A gas chromatograph system, which system comprises:
a) a gas injector for introducing a mobile phase including a sample gas in a carrier gas;
b) a gas chromatograph column of claim 1 comprising a stationary phase suitable for gas chromatograph and mechanically connected to receive said mobile phase from said gas injector for the separation of an analyte in said sample gas; and
c) a detector mechanically connected to said column for the analysis of said separated analyte of said sample gas with an electronic means.

30. A gas chromatograph system, which system comprises:
a) a gas injector for introducing a mobile phase including a sample gas in a carrier gas;
b) a gas chromatograph column of claim 26 comprising a stationary phase suitable for gas chromatograph and mechanically connected to receive said mobile phase from said gas injector for the separation of an analyte in said sample gas; and
c) a detector mechanically connected to said column for the analysis of said separated analyte of said sample gas with an electronic means.

31. A method for analyzing an analyte in a sample, which method comprises:
a) providing a gas chromatograph system of claim 29;
b) vaporizing a sample to a gas phase;
c) injecting said sample gas in a carrier gas into said gas chromatograph system; and
d) allowing separation and detection of an analyte in said sample in said gas chromatograph system to assess the presence, absence or amount of said analyte in said sample.

32. The method of claim 31, wherein the analyte is a molecule or an aggregate or complex thereof.

33. The method of claim 32, wherein the molecule is selected from the group consisting of an inorganic molecule, an organic molecule and a complex thereof.

34. The method of claim 33, wherein the organic molecule is selected from the group consisting of methane, chloroform, benzene and butyric acid.

35. The method of claim 31, wherein the analyte is selected from the group consisting of a chemical compound, a metabolite of a chemical compound and a complex thereof.

36. The method of claim 31, wherein the sample is mammalian sample.

37. The method of claim 36, wherein the mammal is selected from the group consisting of bovine, goat, sheep, equine, rabbit, guinea pig, murine, human, feline, monkey, dog and porcine.

38. The method of claim 31, wherein the sample is a clinical sample.

39. The method of claim 38, wherein the clinical sample is selected from the group consisting of serum, plasma, whole blood, sputum, cerebral spinal fluid, amniotic fluid, urine, gastrointestinal contents, hair, saliva, sweat, gum scrapings and tissue from biopsies.

40. The method of claim 38, wherein the clinical sample is a human clinical sample.

41. The method of claim 31, wherein the sample is a body fluid sample.

42. The method of claim 31, wherein the sample is an atmosphere, water, soil, drug or explosive sample.

43. The method of claim 31, wherein the carrier gas is an inert gas.

44. The method of claim 43, wherein the inert gas is selected from the group consisting of nitrogen, hydrogen, helium and argon.

45. The method of claim 31, wherein the sample is vaporized in a carrier gas.

46. The method of claim 31, wherein the sample is vaporized in the absence of a carrier gas and is then mixed before or while injected into the gas chromatograph system.

47. A method for analyzing an analyte in a sample, which method comprises:
a) providing a gas chromatograph system of claim 30;
b) vaporizing a sample to a gas phase;
c) injecting said sample gas in a carrier gas into said gas chromatograph system; and
d) allowing separation and detection of an analyte in said sample in said gas chromatograph system to assess the presence, absence or amount of said analyte in said sample.
